(19) United States
(12) Patent Application Publication
(10) Pub. No.: US 2026/0341209 A1
(43) Pub. Date: Oct. 29, 2026

(54) Display Substrate, Driving Method Therefor, and Display Apparatus

(71) Applicants: Chengdu BOE Optoelectronics Technology Co., Ltd., Chengdu, Sichuan (CN); BOE Technology Group Co., Ltd., Beijing (CN)

(72) Inventors: Meng LI, Beijing (CN); Taofeng XIE, Beijing (CN); Yuanjie XU, Beijing (CN); Xingliang XIAO, Beijing (CN); Mingzhi CHAI, Beijing (CN); Zhuoan LI, Beijing (CN)

(21) Appl. No.: 18/845,888

(22) PCT Filed: Dec. 20, 2023
(86) PCT No.: PCT/CN2023/140232

§ 371 Date: Sep. 11, 2024

(51) Int. Cl. G09G 3/3233

(52) U.S. Cl. CPC G09G 3/3233; G09G 2300/043; G09G 2300/0819; G09G 2310/08; G09G 2320/0233; G09G 2320/0247; G09G 2320/045; G09G 2330/021

(57) ABSTRACT

A display substrate includes: a data unit, pixel driving circuits arranged in an array, multiple second reset signal lines (Reset2), and multiple second scan signal lines (Gate2). In at least one display frame, the data unit is configured to provide an active level signal to the second reset signal line (Reset2) connected with at least one pixel driving circuit during one time period, and provide an active level signal to the second scan signal line (Gate2) connected with the at least one pixel driving circuit during one time period; or is configured to provide an active level signal to the second reset signal line (Reset2) connected with the at least one pixel driving circuit during at least two time periods, and provide an active level signal to the second scan signal line (Gate2) connected with the at least one pixel driving circuit during at least two time periods.

### CROSS-REFERENCE TO RELATED APPLICATION

The present application is a U.S. National Phase Entry of International Application No. PCT/CN2023/140232 having an international filing date of Dec. 20, 2023, the entire content of which is hereby incorporated by reference.

### TECHNICAL FIELD

The present disclosure relates to the technical field of display technology, in particular to a display substrate, a driving method therefor and a display apparatus.

### BACKGROUND

An Organic Light Emitting Diode (OLED for short) and a Quantum dot Light Emitting Diode (QLED for short) are active light emitting display devices and have advantages such as self-luminescence, wide viewing angle, high contrast ratio, low power consumption, very high response speed, lightness and thinness, flexibility, and low cost. With continuous development of display technologies, a flexible display apparatus (Flexible Display) in which an OLED or QLED is used as a light emitting element and signal control is performed by a Thin Film Transistor (TFT) has become a mainstream product in the field of display at present.

### SUMMARY

The following is a summary of subject matters described herein in detail. This summary is not intended to limit the protection scope of claims.

In a first aspect, the present disclosure provides a display substrate, contents displayed in the display substrate include a plurality of display frames, the display substrate includes: a data unit, pixel driving circuits arranged in an array, a plurality of second reset signal lines and a plurality of second scan signal lines, at least one pixel driving circuit includes a drive transistor, a compensation transistor and a third reset transistor, wherein the drive transistor is connected with a first node, a second node and a third node respectively, the compensation transistor is connected with a second scan signal line, the first node and the third node respectively, and the third reset transistor is connected with a second reset signal line and the second node respectively.

In at least one display frame, the data unit is configured to provide an active level signal to the second reset signal line connected with the at least one pixel driving circuit during one time period, and provide an active level signal to the second scan signal line connected with the at least one pixel driving circuit during one time period, or the data unit is configured to provide an active level signal to the second reset signal line connected with the at least one pixel driving circuit during at least two time periods, and provide an active level signal to the second scan signal line connected with the at least one pixel driving circuit during at least two time periods.

In an exemplary implementation, the display substrate further includes a plurality of first scan signal lines, a plurality of first reset signal lines and a plurality of light emitting signal lines, and the at least one pixel driving circuit further includes a write transistor, a first reset transistor and a first light emitting transistor, wherein the write transistor is connected with a first scan signal line and the second node respectively, the first reset transistor is connected with a first reset signal line and the third node respectively, and the first light emitting transistor is connected with a light emitting signal line and the second node respectively.

In at least one display frame, the data unit is configured to provide an active level signal to the first scan signal line connected with the at least one pixel driving circuit during a first time period, provide an active level signal to the first reset signal line connected with the at least one pixel driving circuit during a second time period, provide an active level signal to the light emitting signal line connected with the at least one pixel driving circuit during a third time period, and provide an inactive level signal to the first scan signal line, the second scan signal line, the first reset signal line, the second reset signal line and the light emitting signal line that are connected with the at least one pixel driving circuit during a fourth time period.

The second time period is before the first time period, and an end time of the second time period is before a start time of the first time period, the first time period is before the fourth time period, and an end time of the first time period is before a start time of the fourth time period, the fourth time period is before the third time period, and an end time of the fourth time period is a start time of the third time period.

In an exemplary implementation, at least one time period during which a signal of the second scan signal line connected with the at least one pixel driving circuit is an active level signal is at least partially overlapped with at least one of the first time period and the second time period, and is not overlapped with at least one of the third time period and the fourth time period.

At least one time period during which a signal of the second reset signal line connected with the at least one pixel driving circuit is an active level signal is not overlapped with at least one of the first time period, the second time period, the third time period, and the fourth time period.

In an exemplary implementation, in a state in which the data unit provides an active level signal to the second reset signal line connected with the at least one pixel driving circuit during one time period, and provides an active level signal to the second scan signal line connected with the at least one pixel driving circuit during one time period, a sixth time period is at least partially overlapped with the first time period and the second time period, respectively, and a fifth time period is after the sixth time period.

The fifth time period is a time period during which the data unit provides an active level signal to the second reset signal line connected with the at least one pixel driving circuit, and the sixth time period is a time period during which the data unit provides an active level signal to the second scan signal line connected with the at least one pixel driving circuit.

In an exemplary implementation, a duration of the sixth time period is greater than a duration of the first time period and greater than a duration of the second time period; and the first time period and the second time period are within the sixth time period.

In an exemplary implementation, a start time of the sixth time period is before a start time of the second time period, an end time of the sixth time period is after the end time of the first time period and before a start time of the fifth time period, and an end time of the fifth time period is a start time of the fourth time period.

In an exemplary implementation, the data unit is further configured to provide an inactive level signal to the first reset signal line, the second reset signal line, and the light emitting signal line that are connected with the at least one pixel driving circuit during the first time period, provide an inactive level signal to the second reset signal line, the first scan signal line, and the light emitting signal line that are connected with the at least one pixel driving circuit during the second time period, provide an inactive level signal to the first reset signal line, the second reset signal line, the first scan signal line, and the second scan signal line that are connected with the at least one pixel driving circuit during the third time period, and provide an inactive level signal to the first reset signal line, the first scan signal line, the second scan signal line and the light emitting signal line that are connected with the at least one pixel driving circuit during the fifth time period.

In an exemplary implementation, in a state in which the data unit provides an active level signal to the second reset signal line connected with the at least one pixel driving circuit during two time periods, and provides an active level signal to the second scan signal line connected with the at least one pixel driving circuit during two time periods, a seventh time period is at least partially overlapped with a fifth time period, an eighth time period is at least partially overlapped with the first time period and the second time period, respectively, and a sixth time period is after the eighth time period.

The fifth and sixth time periods are time periods during which the data unit provides an active level signal to the second reset signal line connected with the at least one pixel driving circuit, and the fifth time period is before the sixth time period, and the seventh and eighth time periods are time periods during which the data unit provides an active level signal to the second scan signal line connected with the at least one pixel driving circuit, and the seventh time period is before the eighth time period.

In an exemplary implementation, a duration of the seventh time period is greater than a duration of the fifth time period, and a duration of the eighth time period is greater than the sum of a duration of the first time period and a duration of the second time period; and the fifth time period is within the seventh time period, and the first time period and the second time period are within the eighth time period.

In an exemplary implementation, a start time of the seventh time period is before a start time of the fifth time period, an end time of the seventh time period is after the start time of the fifth time period, a start time of the eighth time period is before a start time of the second time period, an end time of the eighth time period is after the end time of the first time period and before a start time of the sixth time period, an end time of the sixth time period is a start time of the fourth time period.

In an exemplary implementation, the duration of the eighth time period is greater than the duration of the seventh time period, the duration of the seventh time period is greater than twice a duration of a ninth time period, a start time of the ninth time period is the end time of the seventh time period, and an end time of the ninth time period is the start time of the eighth time period.

The data unit provides an inactive level signal to the first scan signal line, the second scan signal line, the first reset signal line, the second reset signal line, and the light emitting signal line that are connected with the at least one pixel driving circuit during the ninth time period.

In an exemplary implementation, in a state in which the data unit provides an active level signal to the second reset signal line connected with the at least one pixel driving circuit during two time periods, and provides an active level signal to the second scan signal line connected with the at least one pixel driving circuit during two time periods, a seventh time period is at least partially overlapped with a fifth time period and the second time period, respectively, an eighth time period is at least partially overlapped with the first time period, and the sixth time period is after the eighth period.

The fifth and sixth time periods are time periods during which the data unit provides an active level signal to the second reset signal line connected with the at least one pixel driving circuit, and the fifth time period is before the sixth time period, and the seventh and eighth time periods are time periods during which the data unit provides an active level signal to the second scan signal line connected with the at least one pixel driving circuit, and the seventh time period is before the eighth time period.

In an exemplary implementation, a duration of the seventh time period is greater than a sum of a duration of the fifth time period and a duration of the second time period, and a duration of the eighth time period is greater than a duration of the first time period; and the second time period and the fifth time period are within the seventh time period, and the first time period is within the eighth time period.

In an exemplary implementation, a start time of the seventh time period is before a start time of the fifth time period, and an end time of the seventh time period is after the end time of the second time period; a start time of the eighth time period is before the start time of the first time period, and an end time of the eighth time period is after the end time of the first time period and before a start time of the sixth time period, and an end time of the sixth time period is a start time of the fourth time period.

In an exemplary implementation, the duration of the seventh time period is greater than four times the duration of the eighth time period, and greater than four times a duration of a ninth time period, a start time of the ninth time period is the end time of the seventh time period, and an end time of the ninth time period is the start time of the eighth time period.

In an exemplary implementation, in a state in which the data unit provides an active level signal to the second reset signal line connected with the at least one pixel driving circuit during two time periods, and provides an active level signal to the second scan signal line connected with the at least one pixel driving circuit during two time periods, a seventh time period is at least partially overlapped with a fifth time period, an eighth time period is at least partially overlapped with the second time period, a ninth time period is at least partially overlapped with the first time period, and a sixth time period is between the ninth time period and the fourth time period.

The fifth and sixth time periods are time periods during which the data unit provides an active level signal to the second reset signal line connected with the at least one pixel driving circuit, and the fifth time period is before the sixth time period, and the seventh time period, the eighth time period and the ninth time period are time periods during which the data unit provides an active level signal to the second scan signal line connected with the at least one pixel driving circuit, and the seventh time period is before the eighth time period, and the eighth time period is before the ninth time period.

In an exemplary implementation, a duration of the seventh time period is greater than a duration of the fifth time period, a duration of the eighth time period is greater than a duration of the second time period, and a duration of the ninth time period is greater than a duration of the first time period; and the fifth time period is within the seventh time period, the second time period is within the eighth time period, and the first time period is within the ninth time period.

In an exemplary implementation, a start time of the seventh time period is before a start time of the fifth time period, and an end time of the seventh time period is after an end time of the fifth time period; a start time of the eighth time period is before a start time of the second time period, and an end time of the eighth time period is after the end time of the second time period; a start time of the ninth time period is before the start time of the first time period, an end time of the ninth time period is after the end time of the first time period and before a start time of the sixth time period, and an end time of the sixth time period is a start time of the fourth time period.

In an exemplary implementation, a duration of at least one of the seventh time period and the eighth time period is greater than the duration of the ninth time period and greater than a duration of at least one of a tenth time period and an eleventh time period, a start time of the tenth time period is the end time of the seventh time period, an end time of the tenth time period is the start time of the eighth time period, a start time of the eleventh time period is the end time of the eighth time period, and the end time of the eleventh time period is the start time of the ninth time period.

The data unit provides an inactive level signal to the first scan signal line, the second scan signal line, the first reset signal line, the second reset signal line, and the light emitting signal line that are connected with the at least one pixel driving circuit during the tenth time period and the eleventh time period.

In an exemplary implementation, the data unit is further configured to provide an inactive level signal to the first reset signal line, the second reset signal line, and the light emitting signal line that are connected with the at least one pixel driving circuit during the first time period, provide an inactive level signal to the second reset signal line, the first scan signal line, and the light emitting signal line that are connected with the at least one pixel driving circuit during the second time period, provide an inactive level signal to the first reset signal line, the second reset signal line, the first scan signal line, and the second scan signal line that are connected with the at least one pixel driving circuit during the third time period, provide an inactive level signal to the first reset signal line, the first scan signal line, and the light emitting signal line that are connected with the at least one pixel driving circuit during a fifth time period, and provide an inactive level signal to the first reset signal line, the first scan signal line, the second scan signal line and the light emitting signal line that are connected with the at least one pixel driving circuit during a sixth time period.

In an exemplary implementation, the display substrate further includes: a plurality of light emitting signal lines, a plurality of first reset signal lines, a plurality of first initial signal lines, a plurality of second initial signal lines, a plurality of third initial signal lines, a plurality of first scan signal lines, and a plurality of first power supply lines, and the at least one pixel driving circuit further includes: a first reset transistor, a second reset transistor, a write transistor, a first light emitting transistor, a second light emitting transistor, and a capacitor.

A control electrode of the compensation transistor is connected with a second scan signal line, a first electrode of the compensation transistor is connected with the first node, and a second electrode of the compensation transistor is connected with the third node.

A control electrode of the drive transistor is connected with the first node, a first electrode of the drive transistor is connected with the second node, and a second electrode of the drive transistor is connected with the third node.

A control electrode of the write transistor is connected with a first scan signal line, a first electrode of the write transistor is connected with a data signal line, and a second electrode of the write transistor is connected with the second node.

A control electrode of the first reset transistor is connected with a first reset signal line, a first electrode of the first reset transistor is connected with an first initial signal line, and a second electrode of the first reset transistor is connected with the third node.

A control electrode of the second reset transistor is connected with a second reset signal line, a first electrode of the second reset transistor is connected with a second initial signal line, and a second electrode of the second reset transistor is connected with a fourth node.

A control electrode of the third reset transistor is connected with a second reset signal line, a first electrode of the third reset transistor is connected with a third initial signal line, and a second electrode of the third reset transistor is connected with the second node.

A control electrode of the first light emitting transistor is connected with a light emitting signal line, a first electrode of the first light emitting transistor is connected with a first power supply line, and a second electrode of the first light emitting transistor is connected with the second node.

A control electrode of the second light emitting transistor is connected with a light emitting signal line, a first electrode of the second light emitting transistor is connected with the third node, and a second electrode of the second light emitting transistor is connected with the fourth node.

A terminal of the capacitor is connected with a first power supply line, and another terminal of the capacitor is connected with the first node.

In an exemplary implementation, at least one transistor in the at least one pixel driving circuit is a P-type transistor or an N-type transistor, transistor types of the first light emitting transistor and the second light emitting transistor are the same, and transistor types of the second reset transistor and the third reset transistor are the same.

In a second aspect, the present disclosure further provides a display apparatus, including the display substrate described above.

In a third aspect, the present disclosure further provides a driving method for a display substrate, which is configured to drive the display substrate descried above, the method includes: in at least one display frame, providing an active level signal to the second reset signal line connected with the at least one pixel driving circuit during one time period, and providing an active level signal to the second scan signal line connected with the at least one pixel driving circuit during one time period; or providing an active level signal to the second reset signal line connected with the at least one pixel driving circuit during at least two time periods, and providing an active level signal to the second scan signal line connected with the at least one pixel driving circuit during at least two time periods.

Other aspects of the present disclosure may be comprehended after the drawings and the detailed descriptions are read and understood.

### BRIEF DESCRIPTION OF DRAWINGS

Accompanying drawings are used for providing an understanding of technical solutions of the present application and form a part of the specification, are used for explaining the technical solutions of the present application together with embodiments of the present application, but do not constitute a limitation on the technical solutions of the present application.

FIG. 1 is a schematic diagram of a structure of a display substrate.

FIG. 2A is a first schematic diagram of a planar structure of a display substrate.

FIG. 2B is a second schematic diagram of a planar structure of a display substrate.

FIG. 2C is a third schematic diagram of a planar structure of a display substrate.

FIG. 3 is a schematic diagram of a sectional structure of a display substrate.

FIG. 4 is an equivalent circuit diagram of a pixel driving circuit of a display substrate according to an embodiment of the present disclosure.

FIG. 5 is a first working timing diagram of the pixel driving circuit provided in FIG. 4.

FIG. 6 is a second working timing diagram of the pixel driving circuit provided in FIG. 4.

FIG. 7 is a third working timing diagram of the pixel driving circuit provided in FIG. 4.

FIG. 8 is a fourth working timing diagram of the pixel driving circuit provided in FIG. 4.

### DETAILED DESCRIPTION

To make the objectives, technical solutions, and advantages of the present disclosure clearer, the embodiments of the present disclosure will be described in detail below with reference to the accompany drawings. It is to be noted that implementation modes may be implemented in multiple different forms. Those of ordinary skills in the art can easily understand such a fact that implementation modes and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict. In order to keep following description of the embodiments of the present disclosure clear and concise, detailed description of part of known functions and known components are omitted in the present disclosure. The drawings in the embodiments of the present disclosure relate only to the structures involved in the embodiments of the present disclosure, and other structures may be described with reference to conventional designs.

In the accompanying drawings, a size of each composition element, a thickness of a layer, or a region may be exaggerated sometimes for clarity. Therefore, an implementation of the present disclosure is not always limited to the size, and the shape and size of each component in the drawings do not reflect an actual scale. In addition, the accompanying drawings schematically illustrate ideal examples, and an implementation of the present disclosure is not limited to shapes, numerical values, or the like shown in the drawings.

Ordinal numerals “first”, “second”, “third”, etc., in the specification are set not to form limits in numbers but only to avoid confusion between composition elements.

In the specification, for convenience, expressions “central”, “above”, “below”, “front”, “back”, “vertical”, “horizontal”, “top”, “bottom”, “inside”, “outside”, etc., indicating directional or positional relationships are used to illustrate positional relationships between the composition elements, not to indicate or imply that involved devices or elements are required to have specific orientations and be structured and operated with the specific orientations but only to easily and simply describe the present specification, and thus should not be understood as limitations on the present disclosure. The positional relationships between the constituent elements may be changed as appropriate according to a direction by which each constituent element is described. Therefore, appropriate replacements based on situations are allowed, which is not limited to the expressions in the specification.

In the specification, unless otherwise specified and defined, terms “mounting”, “mutual connection”, and “connection” should be understood in a broad sense. For example, a connection may be fixed connection, or a detachable connection, or an integral connection; it may be a mechanical connection or an electrical connection; it may be a direct connection, or an indirect connection through middleware, or internal communication inside two elements. Those of ordinary skills in the art may understand specific meanings of the above terms in the present disclosure according to specific situations.

In the specification, a transistor refers to an element that at least includes three terminals, i.e., a gate electrode, a drain electrode, and a source electrode. The transistor has a channel region between the drain electrode (drain electrode terminal, drain region, or drain) and the source electrode (source electrode terminal, source region, or source), and a current can flow through the drain electrode, the channel region, and the source electrode. It is to be noted that in the specification, the channel region refers to a region through which a current mainly flows.

In the specification, a first electrode may be a drain electrode, and a second electrode may be a source electrode. Or, the first electrode may be a source electrode, and the second electrode may be a drain electrode. In a case that transistors with opposite polarities are used, or in a case that a direction of a current changes during operation of a circuit, or the like, functions of the “source electrode” and the “drain electrode” are sometimes interchangeable. Therefore, the “source electrode” and the “drain electrode” are interchangeable in the specification.

In the specification, “electrical connection” includes connection of composition elements through an element with a certain electrical action. An “element with a certain electrical action” is not particularly limited as long as electrical signals between the connected constituent elements may be sent and received. Examples of the “element with the certain electrical action” not only include an electrode and a wiring, but also include a switching element such as a transistor, a resistor, an inductor, a capacitor, another element with various functions, etc.

In the specification, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the specification, a “film” and a “layer” are interchangeable. For example, a “conductive layer” may be replaced with a “conductive thin film” sometimes. Similarly, an “insulation film” may be replaced with an “insulation layer” sometimes.

Triangle, rectangle, trapezoid, pentagon, hexagon, etc. in this specification are not strictly defined, and they may be approximate triangle, rectangle, trapezoid, pentagon, hexagon, etc. There may be some small deformations caused by tolerance, and there may be chamfer, arc edge, deformation, etc.

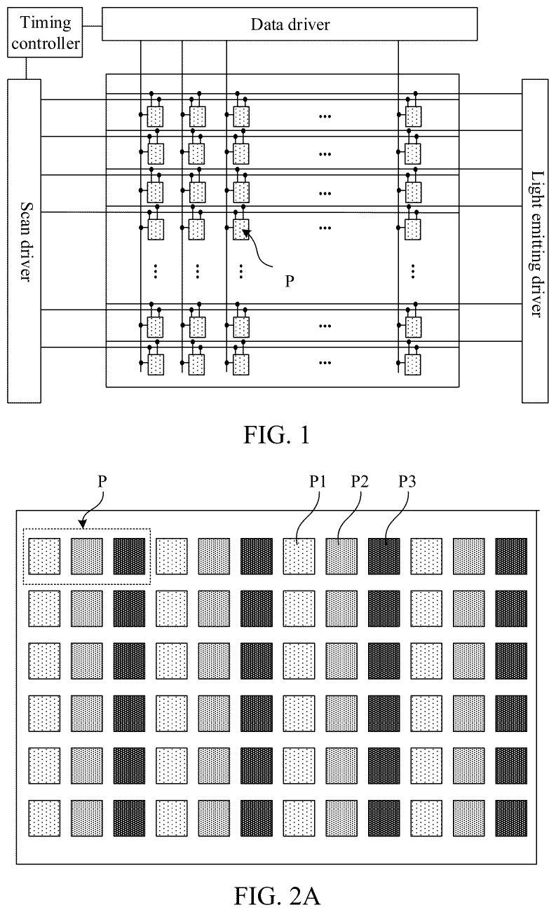

FIG. 1 is a schematic diagram of a structure of a display substrate. As shown in FIG. 1, the display substrate may include a timing controller, a data driver, a scan driver, a light emitting driver, and a pixel array. The timing controller is connected with the data driver, the scan driver, and the light emitting driver, respectively, the data driver is connected with a plurality of data signal lines respectively, the scan driver is connected with a plurality of scan signal lines respectively, and the light emitting driver is connected with a plurality of light emitting signal lines respectively. The pixel array may include multiple sub-pixels Pxij, herein i and j may be natural numbers. At least one sub-pixel Pxij may include a circuit unit and a light emitting device connected to the circuit unit. The circuit unit may include a pixel drive circuit, and the pixel drive circuit may be connected to a scan signal line, a light emitting signal line, and a data signal line respectively. In an exemplary implementation, the timing controller may provide the data driver with a gray-scale value and a control signal which are suitable for the specification of the data driver, provide the scan driver with a clock signal and a scan start signal and the like which are suitable for the specification of the scan driver, and provide the light emitting driver with a clock signal and an emission stop signal and the like which are suitable for the specification of the light emitting driver. The data driver may generate a data voltage to be provided to the data signal line by using the gray-scale value and control signal received from the timing controller. For example, the data driver may sample the gray-scale value by using the clock signal, and apply the data voltage corresponding to the gray-scale value to the data signal line by taking a pixel row as a unit. The scan driver may generate scan signals to be provided to the scan signal lines by receiving the clock signal, the scan starting signal, or the like, from the timing controller. For example, the scan driver may sequentially provide scan signals with on-level pulses to scan signal lines. For example, the scan driver may be constructed in a form of a shift register and may generate a scan signal by sequentially transmitting a scan starting signal provided in a form of an on-level pulse to a next stage circuit under control of the clock signal. The light emitting driver may generate an emission signal to be provided to the light emitting signal line by receiving the clock signal, the emission stop signal, etc., from the timing controller. For example, the light emitting driver may provide emission signals with off-level pulses to the light emitting signal lines sequentially. For example, the light emitting driver may be constructed in a form of the shift register, and generate an emission signal by sequentially transmitting an emission stopping signal provided in the form of an off-level pulse to a next-stage circuit under the control of the clock signal.

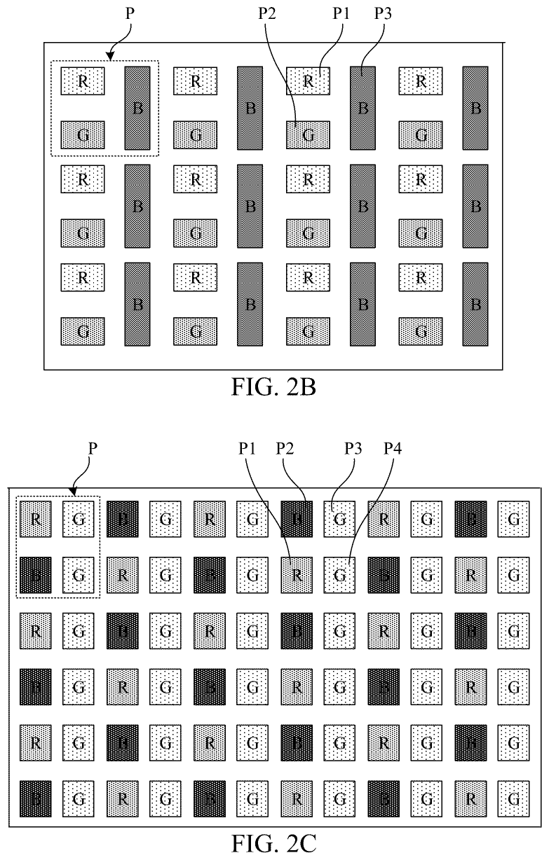

FIG. 2A is a first schematic diagram of a planar structure of a display substrate, FIG. 2B is a second schematic diagram of a planar structure of a display substrate, and FIG. 2C is a third schematic diagram of a planar structure of a display substrate. As shown in FIGS. 2A to 2C, the display substrate may include multiple pixel units P arranged in a matrix, at least one of the multiple pixel units P includes a first sub-pixel P1 emitting light of a first color, a second sub-pixel P2 emitting light of a second color, and a third sub-pixel P3 emitting light of a third color, and the first sub-pixel P1, the second sub-pixel P2, and the third sub-pixel P3 each includes a pixel drive circuit and a light emitting device. Pixel drive circuits in the first sub-pixel P1, the second sub-pixel P2, and the third sub-pixel P3 are connected with a scan signal line, a data signal line, and a light emitting signal line respectively. A pixel drive circuit is configured to, under control of the scan signal line and the light emitting signal line, receive a data voltage transmitted by the data signal line and output a corresponding current to the light emitting device. Light emitting devices in the first sub-pixel P1, the second sub-pixel P2, and the third sub-pixel P3 are respectively connected with the pixel drive circuits of the sub-pixels in which the light emitting devices are located, and the light emitting device is configured to emit light with a corresponding brightness in response to a current output by the pixel drive circuit of the sub-pixel in which the light emitting device is located.

In an exemplary implementation, the first sub-pixel P1 may be a red (R) sub-pixel emitting red light, the second sub-pixel P2 may be a blue (B) sub-pixel emitting blue light, and the third sub-pixel P3 may be a green (G) sub-pixel emitting green light.

In an exemplary implementation, the sub-pixels may be in a shape of rectangular, rhombic, pentagonal, or hexagonal, which is not limited in the present disclosure.

In an exemplary implementation, the pixel unit may include three sub-pixels, herein the three sub-pixels may be arranged side by side horizontally, side by side vertically, or in a form of Chinese character “ [symbol] ” which is not limited in the present disclosure. FIG. 2A illustrates an example in which a pixel unit includes three sub-pixels and the three sub-pixels are arranged side by side horizontally, and FIG. 2B illustrates an example in which a pixel unit includes three sub-pixels and the three sub-pixels are arranged in a form of Chinese character “ [symbol] ”

In an exemplary implementation, the pixel unit may include four sub-pixels, and the four sub-pixels may be arranged side by side horizontally, side by side vertically, in a square, or in a diamond shape, or the like, which is not limited in the present disclosure. FIG. 2C illustrates an example in which a pixel unit includes four sub-pixels and the four sub-pixels are arranged in a square.

In an exemplary implementation, a sub-pixel may be in a shape of a rectangle, a rhombus, a pentagon, or a hexagon. Three sub-pixels may be arranged side by side horizontally, side by side vertically, or in a manner like a Chinese character “ [symbol] ”, the present disclosure is not limited thereto.

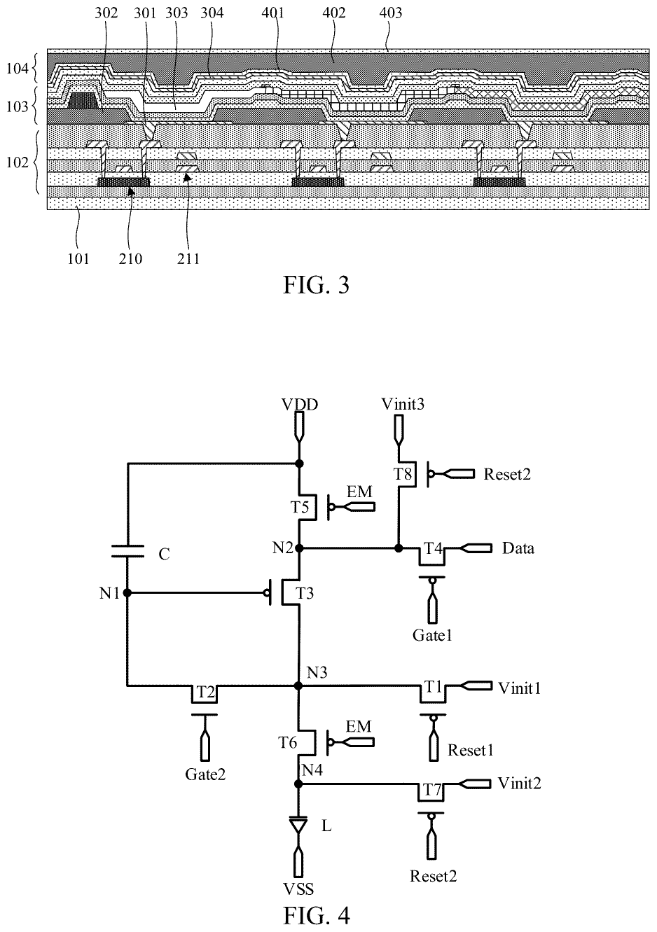

FIG. 3 is a schematic diagram of a sectional structure of a display substrate, and illustrates a structure of three sub-pixels of the display substrate. As shown in FIG. 3, on a plane perpendicular to the display substrate, the display substrate may include a drive circuit layer 102 disposed on a base substrate 101, a light emitting structure layer 103 disposed at a side of the drive circuit layer 102 away from the base substrate 101, and an encapsulation structure layer 104 disposed at a side of the light emitting structure layer 103 away from the base substrate 101. In some possible implementations, the display substrate may include another film layer, such as a touch structure layer, which is not limited here in the present disclosure.

In an exemplary implementation, the base substrate 101 may be a flexible substrate, or may be a rigid substrate. A drive circuit layer 102 of each sub-pixel may include a plurality of transistors and a storage capacitor that form a pixel drive circuit. FIG. 3 shows an example of only one transistor 210 and one capacitor. The light emitting structure layer 103 may include an anode 301, a pixel definition layer 302, an organic light emitting layer 303 and a cathode 304. The anode 301 is connected to a drain electrode of a drive transistor 210 through a via, the organic light emitting layer 303 is connected to the anode 301, and the cathode 304 is connected to the organic light emitting layer 303. The organic light emitting layer 303 emits light of a corresponding color under the driving of the anode 301 and the cathode 304. The encapsulation structure layer 104 may include a first encapsulation layer 401, a second encapsulation layer 402, and a third encapsulation layer 403 which are stacked, the first encapsulation layer 401 and the third encapsulation layer 403 may be made of an inorganic material, the second encapsulation layer 402 may be made of an organic material, and the second encapsulation layer 402 is disposed between the first encapsulation layer 401 and the third encapsulation layer 403, which may ensure that external water vapor cannot enter the light emitting structure layer 103.

In an exemplary implementation mode, the base substrate may be a rigid base substrate or a flexible base substrate, herein the rigid base substrate may be, but is not limited to, one or more of glass and metal foil; the flexible base substrate may be, but is not limited to, one or more of polyethylene terephthalate, ethylene terephthalate, polyether ether ketone, polystyrene, polycarbonate, polyarylate, polyarylester, polyimide, polyvinyl chloride, polyethylene, and textile fiber.

In an exemplary implementation, the organic emitting layer 303 may include an Emitting Layer (EML) and any one or more of a Hole Injection Layer (HIL), a Hole Transport Layer (HTL), an Electron Block Layer (EBL), a Hole Block Layer (HBL), an Electron Transport Layer (ETL), and an Electron Injection Layer (EIL). In an exemplary implementation, one or more of hole injection layers, hole transport layers, electron block layers, hole block layers, electron transport layers and electron injection layers of all sub-pixels may be connected together to form a common connected layer. The emitting layers of adjacent sub-pixels may be overlapped slightly with each other, or may be isolated from each other.

In an exemplary implementation mode, the touch structure layer of each sub-pixel may include a first touch insulation layer disposed on the encapsulation structure layer, a first touch metal layer disposed on the first touch insulation layer, a second touch insulation layer covering the first touch metal layer, a second touch metal layer disposed on the second touch insulation layer, and a touch protective layer covering the second touch metal layer, the first touch metal layer may include a plurality of bridge electrodes, the second touch metal layer may include a plurality of first touch electrodes and second touch electrodes, and a first touch electrode or second touch electrode may be connected with a bridge electrode through a via.

The pixel driving circuit in the display substrate may include a drive transistor and a compensation transistor, the compensation transistor is connected with a gate electrode and a drain electrode of the drive transistor, respectively, to charge and compensate for the gate electrode of the drive transistor. The compensation transistor is a metal oxide transistor. The display substrate will have reliability horizontal patterns after operating at high temperature for a long time. Reliability horizontal patterns appear due to the influence of the positive bias temperature stress of the metal oxide transistor, such that different pixel driving circuits charge the drive transistor to different levels, and thus reliability horizontal patterns appear on the display substrate, which makes the display of the display substrate uneven and affects the display effect of the display substrate.

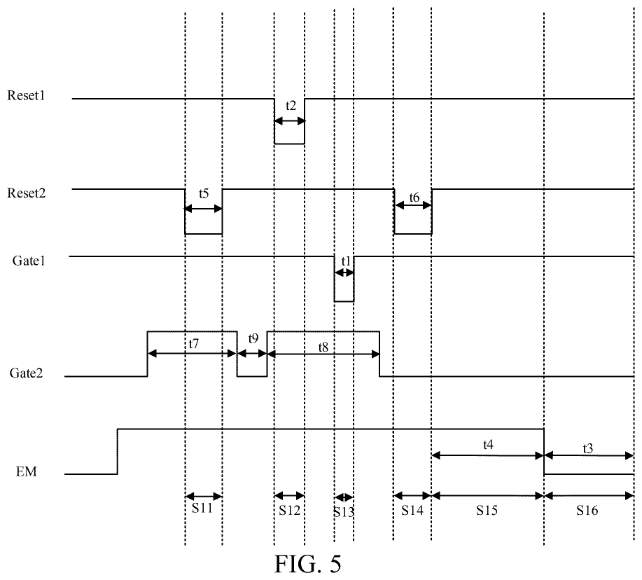

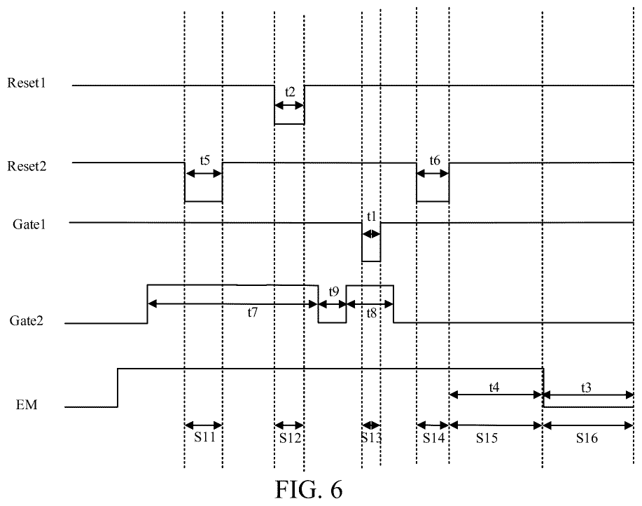

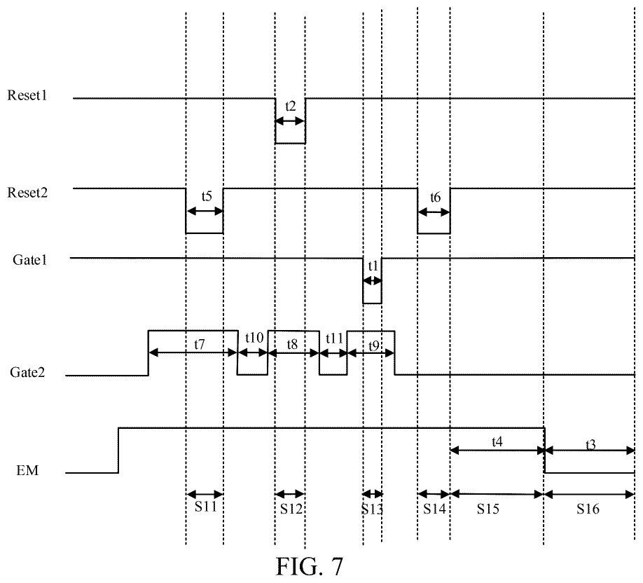

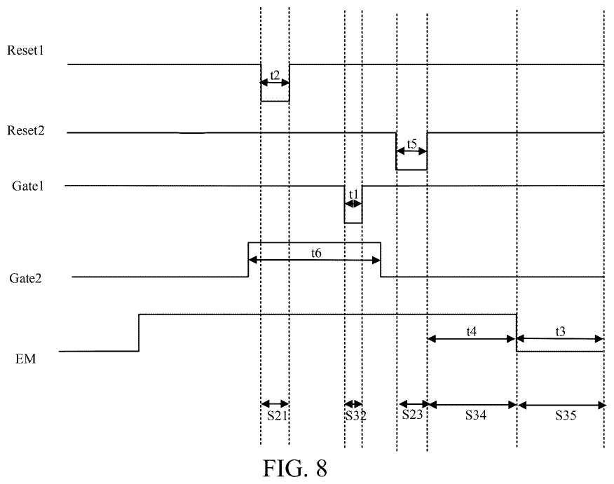

FIG. 4 is an equivalent circuit diagram of a pixel driving circuit of a display substrate according to an embodiment of the present disclosure. FIG. 5 is a first working timing diagram of the pixel driving circuit provided in FIG. 4. FIG. 6 is a second working timing diagram of the pixel driving circuit provided in FIG. 4. FIG. 7 is a third working timing diagram of the pixel driving circuit provided in FIG. 4 and FIG. 8 is a fourth working timing diagram of the pixel driving circuit provided in FIG. 4. As shown in FIGS. 4 to 8, an embodiment of the present disclosure provides a display substrate, the content displayed in the display substrate includes a plurality of display frames, and the display substrate includes: a data unit, pixel driving circuits arranged in an array, a plurality of second reset signal lines Reset2, and a plurality of second scan signal lines Gate2. At least one pixel driving circuit includes a drive transistor T3, a compensation transistor T2, and a third reset transistor T8, herein the drive transistor T3 is connected with a first node N1, a second node N2, and a third node N3, respectively, the compensation transistor T2 is connected with a second scan signal line Gate2, the first node N1, and the third node N3, respectively, and the third reset transistor T8 is connected with a second reset signal line Reset2 and the second node N2, respectively. In at least one display frame, the data unit is configured to provide an active level signal to the second reset signal line Reset2 connected with the at least one pixel driving circuit during one time period, and provide an active level signal to the second scan signal line Gate2 connected with the at least one pixel driving circuit during one time period, or the data unit is configured to provide an active level signal to the second reset signal line Reset2 connected with the at least one pixel driving circuit during at least two time periods, and provide an active level signal to the second scan signal line Gate2 connected with the at least one pixel driving circuit during at least two time periods. FIGS. 5 to 7 illustrate an example in which the data unit is configured to provide an active level signal to the second reset signal line Reset2 connected with the at least one pixel driving circuit during at least two time periods, and provide an active level signal to the second scan signal line Gate2 connected with the at least one pixel driving circuit during at least two time periods. FIG. 8 illustrates an example in which the data unit is configured to provide an active level signal to the second reset signal line Reset2 connected with the at least one pixel driving circuit during one time period, and provide an active level signal to the second scan signal line Gate2 connected with the at least one pixel driving circuit during one time period.

In an exemplary implementation, an active level signal of a signal line refers to a signal that can cause a transistor connected with the signal line to be in an ON state. An inactive level signal of a signal line refers to a signal that can cause a transistor connected with the signal line to be in an OFF state.

The display substrate according to an embodiment of the present disclosure includes a first drive mode and a second drive mode, a refresh rate of the first drive mode is smaller than a refresh rate of the second drive mode, for example, the refresh rate of the first drive mode may be 1 HZ-60 HZ, and the refresh rate of the second drive mode may be 60 HZ-480 HZ. The contents displayed on the display substrate include a plurality of display frames. In the first drive mode, the display frames include a refresh frame and at least one hold frame. In the second driving mode, the display frames only include refresh frames.

In an exemplary implementation, the first drive mode may be referred to as a low frequency drive mode and the second drive mode may be referred to as a high frequency drive mode.

In an exemplary implementation, the refresh rate refers to a quantity of times that the display substrate refreshes data in one second. A refresh rate of a first drive mode set by a same display substrate is fixed, and refresh rates of a first drive mode set by different display substrates may be different. Among them, the refresh rate of the display substrate in the first drive mode may range from 1 Hz to 60 Hz, and, for example, the refresh rate in the first drive mode may be about 10 Hz.

In an exemplary implementation, in the display substrate, the first drive mode and the second drive mode will be adopted for displaying alternately in order to reduce power consumption of a product. In the first drive mode, the display substrate refreshes display data in a refresh frame and maintains the display data refreshed in the refresh frame in a hold frame. In the second drive mode, a display frame may include a refresh frame but not a hold frame. In the second drive mode, the display substrate refreshes display data in a refresh frame. A refresh rate of the display substrate in the second drive mode may range from 60 Hz to 480 Hz and, for example, the refresh rate in the first drive mode may be about 120 Hz.

In an exemplary implementation, the data unit is configured to provide a signal in a refresh frame.

In an exemplary implementation, the time period during which the data unit provides an active level signal to the second scan signal line Gate2 connected with the at least one pixel driving circuit is not overlapped with the at least one time period during which the data unit provides an active level signal to the second scan signal line Gate2 connected with the at least one pixel driving circuit.

In an exemplary implementation, the data unit is configured to provide an active level signal to the second reset signal line Reset2 connected with the at least one pixel driving circuit during one time period and provide an active level signal to the second scan signal line Gate2 connected with the at least one pixel driving circuit during one time period. The time for which an active level signal is provided to the second scan signal line Gate2 connected with the at least one pixel driving circuit can be reduced by reducing the time for the data unit to provide an active level signal to the second reset signal line Reset2 connected with the at least one pixel driving circuit, so as to reduce the on-time of the compensation transistor. Or, the data unit is configured to provide an active level signal to the second reset signal line Reset2 connected with the at least one pixel driving circuit during at least two time periods and provide an active level signal to the second scan signal line Gate2 connected with the at least one pixel driving circuit during at least two time periods. The time for which an active level signal is provided to the second scan signal line Gate2 connected with the at least one pixel driving circuit can be reduced by providing an active level signal to the second scan signal line Gate2 connected with the at least one pixel driving circuit during at least two time periods, so as to reduce the on-time of the compensation transistor. Thus the positive bias temperature stress of the compensation transistor caused by high temperature operation of the display substrate is reduced, the signal consistency of the first node of the at least one pixel driving circuit is ensured, the appearance of reliability horizontal patterns on the display substrate is avoided, the display uniformity of the display substrate is ensured, and the display effect of the display substrate is improved. FIG. 4 is an equivalent circuit diagram of a pixel driving circuit of a display substrate according to an embodiment of the present disclosure. FIG. 5 is a first working timing diagram of the pixel driving circuit provided in FIG. 4. FIG. 6 is a second working timing diagram of the pixel driving circuit provided in FIG. 4. FIG. 7 is a third working timing diagram of the pixel driving circuit provided in FIG. 4 and FIG. 8 is a fourth working timing diagram of the pixel driving circuit provided in FIG. 4.

As shown in FIG. 4, the pixel driving circuit may include eight transistors (first reset transistor T1, compensation transistor T2, drive transistor T3, write transistor T4, first light emitting transistor T5, second light emitting transistor T6, second reset transistor T7, and third reset transistor T8) and a capacitor C.

In an exemplary implementation, the display substrate may further include a plurality of second scan signal lines Gate2, a plurality of first reset signal lines Reset1, a plurality of second reset signal lines Reset2, a plurality of light emitting signal lines EM, a plurality of first initial signal lines Vinit1, a plurality of second initial signal lines Vinit2, a plurality of third initial signal lines Vinit3, and a plurality of first power supply lines VDD.

In an exemplary implementation, the scan signal lines may include a first scan signal line Gate1, a second scan signal line Gate2, a first reset signal line Reset1, and a second reset signal line Reset2.

In an exemplary implementation, as shown in FIG. 4, one terminal of the capacitor C is electrically connected with the first node N1, and the other terminal of the capacitor C is electrically connected with a first power supply line VDD. A control electrode of the first reset transistor T1 is electrically connected with a first reset signal line Reset1, a first electrode of the first reset transistor T1 is electrically connected with a first initial signal line Vinit1, and a second electrode of the first reset transistor T1 is electrically connected with the third node N3. A control electrode of the compensation transistor T2 is electrically connected with a second scan signal line Gate2, a first electrode of the compensation transistor T2 is electrically connected with the first node N1, and a second electrode of the compensation transistor T2 is electrically connected with the second node N2. A control electrode of the drive transistor T3 is electrically connected with the first node N1, a first electrode of the drive transistor T3 is electrically connected with the second node N2, and a second electrode of the drive transistor T3 is electrically connected with the third node N3. A control electrode of the write transistor T4 is electrically connected with a first scan signal line Gate1, a first electrode of the write transistor T4 is electrically connected with a data signal line Data, and a second electrode of the write transistor T4 is electrically connected with the second node N2. A control electrode of the first light emitting transistor T5 is electrically connected with a light emitting signal line EM, a first electrode of the first light emitting transistor T5 is electrically connected with a first power supply line VDD, and a second electrode of the first light emitting transistor T5 is electrically connected with the second node N2. A control electrode of the second light emitting transistor T6 is electrically connected with a light emitting signal line EM, a first electrode of the second light emitting transistor T6 is electrically connected with the third node N3, and a second electrode of the second light emitting transistor T6 is electrically connected with the fourth node N4. A control electrode of the second reset transistor T7 is electrically connected with a second reset signal line Reset2, a first electrode of the second reset transistor T7 is electrically connected with a second initial signal line Vinit2, and a second electrode of the second reset transistor T7 is electrically connected with the fourth node N4. A control electrode of the third reset transistor T8 is electrically connected with a second reset signal line Reset2, a first electrode of the third reset transistor T8 is electrically connected with a third initial signal line Vinit3, and a second electrode of the third reset transistor T8 is electrically connected with the second node N2.

In an exemplary implementation, the second reset signal line Reset2 connected with the second reset transistor T7 and the second reset signal line Reset2 connected with the third reset transistor T8 may be the same signal line, or may be different signal lines with the same signal, which is not limited in the present disclosure.

In an exemplary implementation, as shown in FIG. 4, the display substrate may further include a second power supply line VSS. A light emitting device L may be electrically connected with the fourth node N4 and the second power supply line VSS.

In an exemplary implementation, the light emitting device L may be an Organic Light Emitting Diode (OLED) or a Quantum dot Light Emitting Diode (QLED). Herein, the OLED may include a first electrode (anode), an organic light emitting layer, and a second electrode (cathode) that are stacked, the first electrode of the OLED is connected with the fourth node N4, and the second electrode of the OLED is electrically connected with the second power supply line VSS.

In an exemplary implementation, a signal of the first power supply line VDD is a high-level signal provided continuously, and a signal of the second power supply line VSS is a low-level signal.

In an exemplary implementation, when the first reset signal line Reset1 provides an active level signal, the first reset transistor T1 transmits a first initial signal of the first initial signal line Vinit1 backward to the third node N3 to initialize the charge amount of the third node N3. In an exemplary implementation, when the second scan signal line Gate2 provides an active level signal, the compensation transistor T2 transmits a signal of the third node N3 to the first node N1, so that a threshold compensation may be performed on the drive transistor T3 or the charge amount of the first node N1 may be initialized.

In an exemplary implementation, the drive transistor T3 determines a drive current flowing between the first power supply line VDD and the second power supply line VSS based on a potential difference between the control electrode and the first electrode.

In an exemplary implementation, when an active level signal is input to the first scan signal line Gate1, a data voltage of the data signal line Data is input to the second node N2 by the write transistor T4.

In an exemplary implementation, when an active level signal is input to the light emitting signal line EM, the first light emitting transistor T5 and the second light emitting transistor T6 enable a light emitting element to emit light by forming a path of drive current between the first power supply line VDD and the second power supply line VSS.

In an exemplary implementation, the second reset transistor T7 may be called an anode reset transistor, and when the second reset signal line Reset2 provides an active level signal, the second reset transistor T7 transmits a second initial signal of the second initial signal line Vinit2 to an anode of the light emitting element L to initialize the charge amount of the anode of the light emitting element.

In an exemplary implementation, the third reset transistor T8 may be called a second node reset transistor, and when the second reset signal line Reset2 provides an active level signal, the third reset transistor T8 transmits a third initial signal of the third initial signal line Vinit3 to the second node N2, and the charge amount of the second node N2 may be initialized.

In an exemplary implementation, the transistors may be divided into N-type transistors and P-type transistors according to their characteristics. When a transistor is a P-type transistor, its turn-on voltage is a low-level voltage (e.g., 0V, −5 V, −10 V, or another suitable voltage), and its turn-off voltage is a high-level voltage (e.g., 5 V, 10 V, or another suitable voltage). When a transistor is an N-type transistor, its turn-on voltage is a high-level voltage (e.g., 5 V, 10 V, or another suitable voltage), and its turn-off voltage is a low-level voltage (e.g., 0 V, −5 V, −10 V, or another suitable voltage).

In an exemplary implementation, at least one transistor in the at least one pixel driving circuit is a P-type transistor or an N-type transistor, the first light emitting transistor T5 and the second light emitting transistor T6 are of the same transistor type, and the second reset transistor T7 and the third reset transistor T8 are of the same transistor type. FIG. 4 illustrates an example in which the compensation transistor T2 is an N-type transistor and the remaining transistors are P-type transistors.

In an exemplary implementation, the first reset transistor T1 may be a P-type transistor or an N-type transistor. For example, a P-type transistor may be a low-temperature polysilicon transistor, and an N-type transistor may be a metal oxide transistor.

In an exemplary implementation, the compensation transistor T2 may be an N-type transistor which may reduce a leakage current, improve performance of the pixel driving circuit, and may reduce power consumption of the pixel driving circuit.

In an exemplary implementation, when all transistors in the pixel driving circuit are P-type transistors and N-type transistors, the display substrate uses a Low Temperature +Poly-Silicon Oxide (LTPO) technology. Compared with the LTPS (Temperature +Poly-Silicon) technology, the LTPO technology has a smaller leakage current and a faster pixel response. An additional layer of oxide is added to the display substrate, which reduces the energy consumption needed to excite the pixels, thereby reducing the power consumption during screen display.

In an exemplary implementation, the first initial signal line Vinit1 connected with the at least one pixel driving circuit provides a first initial signal in a refresh frame and a hold frame, the first initial signal being a DC signal, and the voltage value of the first initial signal being constant.

In an exemplary implementation, the second initial signal line Vinit2 connected with the at least one pixel driving circuit provides a second initial signal in a refresh frame and a hold frame, the second initial signal being a DC signal, and the voltage value of the second initial signal being constant.

In an exemplary implementation, the third initial signal line Vinit3 connected with the at least one pixel driving circuit provides a third initial signal in a refresh frame and a hold frame, the third initial signal being a DC signal, and the voltage value of the third initial signal being constant. For example, the voltage value of the third initial signal provided by the third initial signal line Vinit3 may be approximately the voltage value of a signal of the first power supply line VDD. The voltage value of the third initial signal may be about 5 volts to 8 volts.

In an exemplary implementation, as shown in FIGS. 5 to 8, in at least one display frame, the data unit is configured to provide an active level signal to the first scan signal line Gate1 connected with the at least one pixel driving circuit during a first time period t1, provide an active level signal to the first reset signal line Reset1 connected with the at least one pixel driving circuit during a second time period t2, provide an active level signal to the light emitting signal line EM connected with the at least one pixel driving circuit during a third time period t3, and provide an inactive level signal to the first scan signal line Gate1, the second scan signal line Gate2, the first reset signal line Reset1, the second reset signal line Reset2, and the light emitting signal line EM which are connected with the at least one pixel driving circuit during a fourth time period t4. Herein the second time period t2 is before the first time period t1, and the end time of the second time period t2 is before the start time of the first time period t1, the first time period t1 is before the fourth time period t4, and the end time of the first time period t1 is before the start time of the fourth time period t4, the fourth time period t4 is before the third time period t3, and the end time of the fourth time period t4 is the start time of the third time period t3.

In an exemplary implementation, as shown in FIGS. 5 to 8, at least one time period during which a signal of the second scan signal line Gate2 connected with the at least one pixel driving circuit is an active level signal is at least partially overlapped with at least one of the first time period t1 and the second time period t2, and is not overlapped with at least one of the third time period t3 and the fourth time period t4.

In an exemplary implementation, as shown in FIGS. 5 to 8, at least one time period during which a signal of the second reset signal line Reset2 connected with the at least one pixel driving circuit is an active level signal is not overlapped with at least one of the first time period t1, the second time period t2, the third time period t3, and the fourth time period t4.

In an exemplary embodiment, as shown in FIG. 8, in a state in which the data unit provides an active level signal to the second reset signal line Reset2 connected with the at least one pixel driving circuit during one time period, and provides an active level signal to the second scan signal line Gate2 connected with the at least one pixel driving circuit during one time period, a sixth time period t6 is at least partially overlapped with the first time period t1 and the second time period t2, respectively, and a fifth time period t5 is after the sixth time period t6. Herein, the fifth time period t5 is a time period during which the data unit provides an active level signal to the second reset signal line Reset2 connected with the at least one pixel driving circuit, and the sixth time period t6 is a time period during which the data unit provides an active level signal to the second scan signal line Gate2 connected with the at least one pixel driving circuit. In an exemplary implementation, as shown in FIG. 8, the duration of the sixth time period t6 is greater than the sum of the duration of the first time period t1 and the duration of the second time period t2. The first time period t1 and the second time period t2 are within the sixth time period t6.

In an exemplary implementation, as shown in FIG. 8, the start time of the sixth time period t6 is before the start time of the second time period t2, the end time of the sixth time period t6 is after the end time of the first time period t1 and before the start time of the fifth time period t5, the end time of the fifth time period t5 is the start time of the fourth time period t4.

In an exemplary implementation, the duration of the sixth time period may be greater than 18 H.

In an exemplary implementation, as shown in FIG. 8, the data unit is further configured to provide an inactive level signal to the first reset signal line Reset1, the second reset signal line Reset2, and the light emitting signal line EM that are connected with the at least one pixel driving circuit during a first time period t1, provide an inactive level signal to the second reset signal line Reset2, the first scan signal line Gate1, and the light emitting signal line EM that are connected with the at least one pixel driving circuit during a second time period t2, provide an inactive level signal to the first reset signal line Reset1, the second reset signal line Reset2, the first scan signal line Gate1, and the second scan signal line Gate2 that are connected with the at least one pixel driving circuit during a third time period t3, and provide an inactive level signal to the first reset signal line Reset1, the first scan signal line Gate1, and the second scan signal line Gate2, and the light emitting signal line EM that are connected with the at least one pixel driving circuit during a fifth time period t5.

In the present disclosure, the time for which an active level signal is provided to the second scan signal line connected with the at least one pixel driving circuit is reduced by reducing the time period during which the data unit provides an active level signal to the second reset signal line connected with the at least one pixel driving circuit, the positive bias temperature stress of the compensation transistor can be reduced, the display uniformity of the display substrate can be improved, and the display effect of the display substrate for displaying a low gray-scale display picture can also be improved without affecting the display effect of the display substrate.

In an exemplary implementation, as shown in FIG. 8, in at least one display frame, the signal of the first reset signal line Reset1 connected with the at least one pixel driving circuit is a single pulse signal, the signal of the second reset signal line Reset2 connected with the at least one pixel driving circuit is a single pulse signal, the signal of the first scan signal line Gate1 connected with the at least one pixel driving circuit is a single pulse signal, the signal of the second scan signal line Gate2 connected with the at least one pixel driving circuit is a single pulse signal, and the signal of the light emitting signal line EM connected with the at least one pixel driving circuit is a single pulse signal.

In an exemplary implementation, as shown in FIG. 5, in a state in which the data unit provides an active level signal to the second reset signal line Reset2 connected with the at least one pixel driving circuit during two time periods, and provides an active level signal to the second scan signal line Gate2 connected with the at least one pixel driving circuit during two time periods, a seventh time period t7 is at least partially overlapped with the fifth time period t5, an eighth time period t8 is at least partially overlapped with the first time period t1 and the second time period t2, respectively, and the sixth time period t6 is after the eighth time period t8. Herein, the fifth and sixth time periods t5 and t6 are time periods during which the data unit provides an active level signal to the second reset signal line Reset2 connected with the at least one pixel driving circuit, and the fifth time period t5 is before the sixth time period t6, and the seventh and eighth time periods t7 and t8 are time periods during which the data units provide an active level signal to the second scan signal line Gate2 connected with the at least one pixel driving circuit, and the seventh time period t7 is before the eighth time period t8.

In an exemplary implementation, as shown in FIG. 5, the duration of the seventh time period t7 is greater than the duration of the fifth time period t5, and the duration of the eighth time period t8 is greater than the sum of the duration of the first time period t1 and the duration of the second time period t2; the fifth time period t5 is within the seventh time period t7, and the first time period t1 and the second time period t2 are within the eighth time period t8.

In an exemplary implementation, as shown in FIG. 5, the start time of the seventh time period t7 is before the start time of the fifth time period t5, the end time of the seventh period t7 is after the start time of the fifth time period t5, the start time of the eighth time period t8 is before the start time of the second time period t2, the end time of the eighth time period t8 is after the end time of the first time period t1 and before the start time of the sixth time period t6, and the end time of the sixth time period t6 is the start time of the fourth time period t4.

In an exemplary implementation, as shown in FIG. 5, the duration of the eighth time period t8 is greater than the duration of the seventh time period t7, the duration of the seventh time period t7 is greater than twice the duration of a ninth time period t9, the start time of the ninth time period t9 is the end time of the seventh time period t7, and the end time of the ninth time period t9 is the start time of the eighth time period t8. The data unit provides an inactive level signal to the first scan signal line Gate1, the second scan signal line Gate2, the first reset signal line Reset1, the second reset signal line Reset2, and the light emitting signal line EM that are connected with the at least one pixel driving circuit during the ninth time period t9.

In an exemplary implementation, in a state in which the duration between the start time of the seventh time period t7 and the end time of the eighth time period t8 is 38 H, the duration of the seventh time period t7 may be 14 H, the duration of the eighth time period t8 may be 18 H, and the duration of the ninth time period may be 6 H. The durations of the seventh time period, the eighth time period, and the ninth time period may be defined based on a display state of the display substrate, and are not limited in the present disclosure.

In a working process of the pixel driving circuit shown in FIG. 5, the data unit provides an active level signal to the second scan signal line Gate2 connected with the at least one pixel driving circuit during two discontinuous time periods, so that the positive bias temperature stress of the compensation transistor can be reduced, and the display uniformity of the display substrate can be improved.

In an exemplary implementation, as shown in FIG. 6, in a state in which the data unit provides an active level signal to the second reset signal line Reset2 connected with the at least one pixel driving circuit during two time periods, and provides an active level signal to the second scan signal line Gate2 connected with the at least one pixel driving circuit during two time periods, the seventh time period t7 is at least partially overlapped with the fifth time period t5 and the second time period t2, respectively, the eighth time period t8 is at least partially overlapped with the first time period t1, and the sixth time period t6 is after the eighth time period t8. Herein, the fifth and sixth time periods t5 and t6 are time periods during which the data unit provides an active level signal to the second reset signal line Reset2 connected with the at least one pixel driving circuit, and the fifth time period t5 is before the sixth time period t6, and the seventh and eighth time periods t7 and t8 are time periods during which the data unit provides an active level signal to the second scan signal line Gate2 connected with the at least one pixel driving circuit, and the seventh time period t7 is before the eighth time period t8.

In an exemplary implementation, as shown in FIG. 6, the duration of the seventh time period t7 is greater than the sum of the duration of the fifth time period t5 and the duration of the second time period t2, and the duration of the eighth time period t8 is greater than the duration of the first time period t1. The second time period t2 and the fifth time period t5 are within the seventh time period t7, and the first time period t1 is within the eighth time period t8. In an exemplary implementation, as shown in FIG. 6, the start time of the seventh time period t7 is before the start time of the fifth time period t5, the end time of the seventh period t7 is after the end time of the second time period t2, the start time of the eighth time period t8 is before the start time of the first time period t1, the end time of the eighth time period t8 is after the end time of the first time period t1 and before the start time of the sixth time period t6, and the end time of the sixth time period t6 is the start time of the fourth time period t4.

In an exemplary implementation, as shown in FIG. 6, the duration of the seventh time period t7 is greater than four times the duration of the eighth time period t8 and greater than four times the duration of the ninth time period t9, the start time of the ninth time period t9 is the end time of the seventh time period t7, and the end time of the ninth time period t9 is the start time of the eighth time period t8.

In the exemplary implementation, as shown in FIG. 6, in a state in which the duration between the start time of the seventh time period t7 and the end time of the eighth time period t8 is 38 H, the duration of the seventh time period t7 may be 26 H, the duration of the eighth time period t8 may be 6 H, and the duration of the ninth time period t9 may be 6 H.

In a working process of the pixel driving circuit shown in FIG. 6, the data unit provides an active level signal to the second scan signal line Gate2 connected with the at least one pixel driving circuit during two discontinuous time periods, so that the positive bias temperature stress of the compensation transistor can be reduced, and the display uniformity of the display substrate can be improved.

In an exemplary implementation, as shown in FIGS. 5 and 6, in at least one display frame, the signal of the first reset signal line Reset1 connected with the at least one pixel driving circuit is a single pulse signal, the signal of the second reset signal line Reset2 connected with the at least one pixel driving circuit is a two-pulse signal, the signal of the first scan signal line Gate1 connected with the at least one pixel driving circuit is a single pulse signal, the signal of the second scan signal line Gate2 connected with the at least one pixel driving circuit is a two-pulse signal, and the signal of the light emitting signal line EM connected with the at least one pixel driving circuit is a single pulse signal.

In an exemplary implementation, as shown in FIG. 7, in a state in which the data unit provides an active level signal to the second reset signal line Reset2 connected with the at least one pixel driving circuit during two time periods, and provides an active level signal to the second scan signal line Gate2 connected with the at least one pixel driving circuit during two time periods, the seventh time period t7 is at least partially overlapped with the fifth time period t5, the eighth time period t8 is at least partially overlapped with the second time period t2, the ninth time period t9 is at least partially overlapped with the first time period t1, and the sixth time period t6 is between the ninth time period t9 and the fourth time period t4. Herein, the fifth and sixth time periods t5 and t6 are time periods during which the data unit provides an active level signal to the second reset signal line Reset2 connected with the at least one pixel driving circuit, and the fifth time period t5 is before the sixth time period t6, and the seventh time period t7, the eighth time period t8 and the ninth time period t9 are time periods during which the data unit provides an active level signal to the second scan signal line Gate2 connected with the at least one pixel driving circuit, and the seventh time period t7 is before the eighth time period t8 and the eighth time period t8 is before the ninth time period t9.

In an exemplary implementation, as shown in FIG. 7, the duration of the seventh time period t7 is greater than the duration of the fifth time period t5, the duration of the eighth time period t8 is greater than the duration of the second time period t2, and the duration of the ninth time period t9 is greater than the duration of the first time period t1. The fifth time period t5 is within the seventh time period t7, the second time period t2 is within the eighth time period t8, and the first time period t1 is within the ninth time period t9.

In an exemplary implementation, as shown in FIG. 7, the start time of the seventh time period t7 is before the start time of the fifth time period t5, and the end time of the seventh time period t7 is after the end time of the fifth time period t5. The start time of the eighth time period t8 is before the start time of the second time period t2, and the end time of the eighth time period t8 is after the end time of the second time period t2. The start time of the ninth time period t9 is before the start time of the first time period t1, and the end time of the ninth time period t9 is after the end time of the first time period t1 and before the start time of the sixth time period t6, and the end time of the sixth time period t6 is the start time of the fourth time period t4.

In an exemplary implementation, as shown in FIG. 7, the duration of at least one of the seventh time period t7 and the eighth time period t8 is greater than the duration of the ninth time period t9, and greater than the duration of at least one of a tenth time period t10 and an eleventh time period t11. The start time of the tenth time period t10 is the end time of the seventh time period t7, and the end time of the tenth time period t10 is the start time of the eighth time period t8. The start time of the eleventh time period t11 is the end time of the eighth time period t8, and the end time of the eleventh time period t11 is the start time of the ninth time period t9.

In an exemplary implementation, in a state in which the duration between the start time of the seventh time period t7 and the end time of the eighth time period t8 is 38 H, the duration of the seventh time period t7 may be 10 H, the duration of the tenth time period t10 may be 6 H, the duration of the eighth time period t8 may be 10 H, the duration of the eleventh time period t11 may be 6 H, and the duration of the ninth time period t9 may be 6 H.

In an exemplary implementation, the duration of the seventh time period t7 may be greater than 10 H. The duration of the tenth time period t10 may be greater than 6 H, the duration of the eighth time period t8 may be greater than 10 H, the duration of the eleventh time period t11 may be greater than 6H, and the duration of the ninth time period t9 may be greater than 6 H.

In an exemplary implementation, as shown in FIG. 7, the data unit provides an inactive level signal to the first scan signal line Gate1, the second scan signal line Gate2, the first reset signal line Reset1, the second reset signal line Reset2, and the light emitting signal line EM that are connected with the at least one pixel driving circuit during the tenth time period t10 and the eleventh time period t11.

In an exemplary implementation, as shown in FIG. 7, in at least one display frame, the signal of the first reset signal line Reset1 connected with the at least one pixel driving circuit is a single pulse signal, the signal of the second reset signal line Reset2 connected with the at least one pixel driving circuit is a two-pulse signal, the signal of the first scan signal line Gate1 connected with the at least one pixel driving circuit is a single pulse signal, the signal of the second scan signal line Gate2 connected with the at least one pixel driving circuit is a three-pulse signal, and the signal of the light emitting signal line EM connected with the at least one pixel driving circuit is a single pulse signal.

In a working process of the pixel driving circuit shown in FIG. 7, the data unit provides an active level signal to the second scan signal line Gate2 connected with the at least one pixel driving circuit during three discontinuous time periods, so that the positive bias temperature stress of the compensation transistor can be reduced, and the display uniformity of the display substrate can be improved.

In an exemplary implementation, as shown in FIGS. 5 to 7, the data unit is further configured to provide an inactive level signal to the first reset signal line Reset1, the second reset signal line Reset2, and the light emitting signal line EM that are connected with the at least one pixel driving circuit during a first time period t1, provide an inactive level signal to the second reset signal line Reset2, the first scan signal line Gate1, and the light emitting signal line EM that are connected with the at least one pixel driving circuit during a second time period t2, provide an inactive level signal to the first reset signal line Reset1, the second reset signal line Reset2, the first scan signal line Gate1, and the second scan signal line Gate2 that are connected with the at least one pixel driving circuit during a third time period t3, provide an inactive level signal to the first reset signal line Reset1, the first scan signal line Gate1 and the light emitting signal line EM that are connected with the at least one pixel driving circuit during a fifth time period t5, and provide an inactive level signal to the first reset signal line Reset1, the first scan signal line Gate1, the second scan signal line Gate2 and the light emitting signal line EM that are connected with the at least one pixel driving circuit during a sixth time period t6.

In an exemplary implementation, taking the pixel driving circuit as FIG. 4 as an example, the working process of the pixel driving circuit provided by an exemplary embodiment is explained in connection with an example in which the compensation transistor T2 is an N-type transistor, and the first reset transistor T1, the drive transistor T3, the write transistor T4, the first light emitting transistor T5, the second light emitting transistor T6, the second reset transistor T7, and the third reset transistor T8 are P-type transistors, as shown in FIGS. 4 to 5. As shown in FIG. 5, in a refresh frame of the at least one display frame, the working process of the at least one pixel driving circuit may include a first stage S11, a second stage S12, a third stage S13, a fourth stage S14, a fifth stage S15, and a sixth stage S16, herein the first stage S11 is a stage where the fifth time period t5 is located, the second stage S12 is a stage where the second time period t2 is located, the third stage S13 is a stage where the first time period t1 is located, the fourth stage S14 is a stage where the sixth time period t6 is located, the fifth stage S15 is a stage where the fourth time period t4 is located, and the sixth stage S16 is a stage where the third time period t3 is located.

In the first stage S11, that is, a first initialization stage, signals of the first scan signal line Gate1, the second scan signal line Gate2, the first reset signal line Reset1, and the light emitting signal line EM are all high-level signals, and the signal of the second reset signal line Reset2 is a low-level signal. The signal of the second reset signal line Reset2 is a low-level signal, the second reset transistor T7 and the third reset transistor T8 are turned on, and a second initial signal of the second initial signal line Vinit2 is written to the fourth node N4, so as to initialize (reset) the fourth node N4 (i.e., the first electrode of the light emitting device), empty the pre-stored voltage inside the fourth node N4 to complete the initialization. Since the drive transistor T3 is turned on, a third initial signal of the third initial signal line Vinit3 is written to the second node N2 and the third node N3, so as to initialize (reset) the second node N2 and the third node N3, empty the pre-stored voltage inside the second node N2 and the third node N3 to complete the initialization. The signal of the second scan signal line Gate2 is a high-level signal, the compensation transistor T2 is turned on, the signal of the third node N3 is written to the first node N1, so as to initialize (reset) the first node N1, empty the pre-stored voltage inside the first node N1 to complete the initialization. In this stage, the drive transistor T3 is turned on. The signals of the first scan signal line Gate1, the second reset signal line Reset2, and the light emitting signal line EM are high-level signals, and the write transistor T4, the first light emitting transistor T5, the second light emitting transistor T6, the second reset transistor T7, and the third reset transistor T8 are turned off. The light emitting element L does not emit light in this stage.

In the second stage S12, that is, a second initialization stage, the signals of the first scan signal line Gate1, the second scan signal line Gate2, the second reset signal line Reset2, and the light emitting signal line EM are all high-level signals, and the signal of the first reset signal line Reset1 is a low-level signal. The signal of the first reset signal line Reset1 is a low-level signal, the first reset transistor T1 is turned on, a first initial signal of the first initial signal line Vinit1 is written to the third node N3, so as to initialize (reset) the third node N3, empty the pre-stored voltage inside the third node N3 to complete the initialization. Since the signal of the second scan signal line Gate2 is a high-level signal, and the compensation transistor T2 is turned on, the signal of the third node N3 is continuously written to the first node N1, so as to initialize (reset) the first node N1, empty the pre-stored voltage inside the first node N1 to complete the initialization. The signals of the first scan signal line Gate1, the second reset signal line Reset2, and the light emitting signal line EM are all high-level signals, and the write transistor T4, the second reset transistor T7, the third reset transistor T8, the first light emitting transistor T5, and the second light emitting transistor T6 are turned off. The light emitting element L does not emit light in this stage.

In the third stage S13, that is, a data writing stage, the signals of the second scan signal line Gate2, the first reset signal line Reset1, the second reset signal line Reset2, and the light emitting signal line EM are all high-level signals, the signal of the first scan signal line Gate1 is a low-level signal, and a data voltage is written to the data signal line Data. The signal of the first scan signal line Gate1 is a low-level signal, the write transistor T4 is turned on, the signal of the second scan signal line Gate2 is a high-level signal, the compensation transistor T2 is turned on, the data voltage output from the data signal line Data is written to the first node N1 through the turned-on write transistor T4, the second node N2, the turned-on drive transistor T3, the third node N3 and the turned-on compensation transistor T2, and the difference between the second data voltage output from the data signal line Data and the threshold voltage of the drive transistor T3 is charged into the capacitor C until the voltage of the first node N1 is Vdata−|Vth|, where Vdata is the data voltage output from the data signal line Data and Vth is the threshold voltage of the drive transistor T3. The signals of the first reset signal line Reset1, the second reset signal line Reset2, and the light emitting signal line EM are all high-level signals, and the first reset transistor T1, the second reset transistor T7, the third reset transistor T8, the first light emitting transistor T5, and the second light emitting transistor T6 are turned off. The light emitting element L does not emit light in this stage.

In the fourth stage S14, that is, a third initialization stage, the signals of the first scan signal line Gate1, the first reset signal line Reset1, and the light emitting signal line EM are all high-level signals, and the signals of the second scan signal line Gate2 and the second reset signal line Reset2 are low-level signals. The signal of the second reset signal line Reset2 is a low-level signal, the second reset transistor T7 and the third reset transistor T8 are turned on, and a second initial signal of the second initial signal line Vinit2 is written to the fourth node N4, so as to initialize (reset) the fourth node N4 (i.e., the first electrode of the light emitting device), empty the pre-stored voltage inside the fourth node N4 to complete the initialization. Since the drive transistor T3 is turned on, a third initial signal of the third initial signal line Vinit3 is written to the second node N2 and the third node N3, so as to initialize (reset) the second node N2 and the third node N3 and empty the pre-stored voltage inside the second node N2 and the third node N3 to complete the initialization. The signals of the first reset signal line Reset1, the first scan signal line Gate1, and the light emitting signal line EM are all high-level signals, the signal of the second scan signal line Gate2 is a high-level signal, and the compensation transistor T2, the write transistor T4, the first reset transistor T1, the first light emitting transistor T5, and the second light emitting transistor T6 are turned off. The light emitting element L does not emit light in this stage.

In the fifth stage S15, that is, a hold stage, the signals of the first scan signal line Gate1, the first reset signal line Reset1, the second reset signal line Reset2, and the light emitting signal line EM are all high-level signals, and the signal of the second scan signal line Gate2 is a low-level signal. The signals of the first scan signal line Gate1, the first reset signal line Reset1, the second reset signal line Reset2, and the light emitting signal line EM are all high-level signals, and the signal of the second scan signal line Gate2 is a low-level signal, the first reset transistor T1, the compensation transistor T2, the write transistor T4, the first light emitting transistor T5, the second light emitting transistor T6, the second reset transistor T7, and the third reset transistor T8 are turned off. In this stage, the drive transistor T3 is turned on, so that a third initial signal of the third initial signal line Vinit3 has enough time to act on the first and second electrodes of the drive transistor T3. In this stage, the voltage value of the signal of the first node N1 is greater than the voltage value of the signal of the second node N2, so that the drive transistor T3 can be in a bias voltage state for a long time. Therefore, a hysteresis state of the drive transistor T3 is improved, and the low-frequency flicker problem of the display substrate is improved.

In the sixth stage S16, that is, a light emitting stage, the signals of the first scan signal line Gate1, the first reset signal line Reset1, and the second reset signal line Reset2 are all high-level signals, and the signals of the second scan signal line Gate2 and the light emitting signal line EM are low-level signals. The signal of the light emitting signal line EM is a low-level signal, the first light emitting transistor T5 and the second light emitting transistor T6 are turned on, and a power supply voltage output from the first power supply line VDD supplies a driving voltage to the fourth node N4 through the first light emitting transistor T5, the drive transistor T3, and the second light emitting transistor T6 that are turned, so as to drive the light emitting device L to emit light.

In a drive process of the refresh frame of the pixel driving circuit, a drive current flowing through the drive transistor T3 is determined by a voltage difference between a control electrode and a first electrode of the third transistor T3. Because the voltage of the first node N1 is Vdata−|Vth|, the drive current of the drive transistor T3 is as follows.

I=K*(Vgs−Vth)²=K*[(Vdd−Vdata+|Vth|)−Vth]²=K*[(Vdd−Vdata]²

Among them, I is the drive current flowing through the drive transistor T3, i.e., a drive current for driving the light emitting device L. The K is a constant. Vgs is the voltage difference between the control electrode and the first electrode of the drive transistor T3. Vth is the threshold voltage of the drive transistor T3. Vdata is the second data voltage output by the data signal line Data. Vdd is the power supply voltage output by the first power supply terminal VDD.

In an exemplary implementation, in the driving method for pixel driving circuits provided in FIGS. 6 and 7 and the driving method for pixel driving circuits provided in FIG. 5, during the fifth time period, the second time period, the first time period, the sixth time period, the fourth time period, and the third time period, signals of the first scan signal line, the second scan signal line, the first reset signal line, the second reset signal line, and the light emitting signal line that are connected with the pixel driving circuits are the same. Therefore working processes of the pixel driving circuits are all the same, which is not limited in the present disclosure.

In an exemplary implementation, taking the pixel driving circuit as FIG. 4 as an example, the working process of the pixel driving circuit provided by an exemplary embodiment is explained in connection with an example where the compensation transistor T2 is an N-type transistor, the first reset transistor T1, the drive transistor T3, the write transistor T4, the first light emitting transistor T5, the second light emitting transistor T6, the second reset transistor T7, and the third reset transistor T8 are P-type transistors, as shown in FIG. 4 and FIG. 8. As shown in FIG. 8, in a refresh frame of the at least one display frame, the working process of the at least one pixel driving circuit may include a first stage S21, a second stage S22, a third stage S23, a fourth stage S24, and a fifth stage S25, herein the first stage S21 is a stage where the second time period t2 is located, the second stage S22 is a stage where the first time period t1 is located, the third stage S23 is a stage where the fifth time period t5 is located, the fourth stage S24 is a stage where the fourth time period t4 is located, and the fifth stage S25 is a stage where the third time period t3 is located.

In the first stage S21, that is, a first initialization stage, the signals of the first scan signal line Gate1, the second scan signal line Gate2, the second reset signal line Reset2, and the light emitting signal line EM are all high-level signals, and the signal of the first reset signal line Reset1 is a low-level signal. The signal of the first reset signal line Reset1 is a low-level signal, the first reset transistor T1 is turned on, a first initial signal of the first initial signal line Vinit1 is written to the third node N3, so as to initialize (reset) the third node N3 and empty the pre-stored voltage inside the third node N3 to complete the initialization. Since the signal of the second scan signal line Gate2 is a high-level signal, and the compensation transistor T2 is turned on, the signal of the third node N3 is continuously written to the first node N1, so as to initialize (reset) the first node N1 and empty the pre-stored voltage inside the first node N1 to complete the initialization. The signals of the first scan signal line Gate1, the second reset signal line Reset2, and the light emitting signal line EM are all high-level signals, and the write transistor T4, the second reset transistor T7, the third reset transistor T8, the first light emitting transistor T5, and the second light emitting transistor T6 are turned off. The light emitting element L does not emit light in this stage.

In the second stage S22, that is, a data writing stage, the signals of the second scan signal line Gate2, the first reset signal line Reset1, the second reset signal line Reset2, and the light emitting signal line EM are all high-level signals, the signal of the first scan signal line Gate1 is a low-level signal, and a data voltage is written to the data signal line Data. The signal of the first scan signal line Gate1 is a low-level signal, the write transistor T4 is turned on, the signal of the second scan signal line Gate2 is a high-level signal, the compensation transistor T2 is turned on, the data voltage output from the data signal line Data is written to the first node N1 through the turned-on write transistor T4, the second node N2, the turned-on drive transistor T3, the third node N3 and the turned-on compensation transistor T2, and the difference between the second data voltage output from the data signal line Data and the threshold voltage of the drive transistor T3 is charged into the capacitor C until the voltage of the first node N1 is Vdata-|Vth|, where Vdata is the data voltage output from the data signal line Data and Vth is the threshold voltage of the drive transistor T3. The signals of the first reset signal line Reset1, the second reset signal line Reset2, and the light emitting signal line EM are all high-level signals, and the first reset transistor T1, the second reset transistor T7, the third reset transistor T8, the first light emitting transistor T5, and the second light emitting transistor T6 are turned off. The light emitting element L does not emit light in this stage.

In the third stage S23, that is, a second initialization stage, the signals of the first scan signal line Gate1, the first reset signal line Reset1, and the light emitting signal line EM are all high-level signals, and the signals of the second scan signal line Gate2 and the second reset signal line Reset2 are low-level signals. The signal of the second reset signal line Reset2 is a low-level signal, the second reset transistor T7 and the third reset transistor T8 are turned on, and a second initial signal of the second initial signal line Vinit2 is written to the fourth node N4, so as to initialize (reset) the fourth node N4 (i.e., the first electrode of the light emitting device), empty the pre-stored voltage inside the fourth node N4 to complete the initialization. Since the drive transistor T3 is turned on, a third initial signal of the third initial signal line Vinit3 is written to the second node N2 and the third node N3, so as to initialize (reset) the second node N2 and the third node N3 and empty the pre-stored voltage inside the second node N2 and the third node N3 to complete the initialization. The signals of the first reset signal line Reset1, the first scan signal line Gate1, and the light emitting signal line EM are all high-level signals, the signal of the second scan signal line Gate2 is a high-level signal, and the compensation transistor T2, the write transistor T4, the first reset transistor T1, the first light emitting transistor T5, and the second light emitting transistor T6 are turned off. The light emitting element L does not emit light in this stage.

In the fourth stage S24, that is, a hold stage, the signals of the first scan signal line Gate1, the first reset signal line Reset1, the second reset signal line Reset2, and the light emitting signal line EM are all high-level signals, and the signal of the second scan signal line Gate2 is a low-level signal. The signals of the first scan signal line Gate1, the first reset signal line Reset1, the second reset signal line Reset2, and the light emitting signal line EM are all high-level signals, and the signal of the second scan signal line Gate2 is a low-level signal, the first reset transistor T1, the compensation transistor T2, the write transistor T4, the first light emitting transistor T5, the second light emitting transistor T6, the second reset transistor T7, and the third reset transistor T8 are turned off. In this stage, the drive transistor T3 is turned on, so that a third initial signal of the third initial signal line Vinit3 has enough time to act on the first and second electrodes of the drive transistor T3. In this stage, the voltage value of the signal of the first node N1 is greater than the voltage value of the signal of the second node N2, so that the drive transistor T3 can be in a bias voltage state for a long time. Therefore, a hysteresis state of the drive transistor T3 is improved, and thus the low-frequency flicker problem of the display substrate is improved.

In the fifth stage S25, that is, a light emitting stage, the signals of the first scan signal line Gate1, the first reset signal line Reset1, and the second reset signal line Reset2 are all high-level signals, and the signals of the second scan signal line Gate2 and the light emitting signal line EM are low-level signals. The signal of the light emitting signal line EM is a low-level signal, the first light emitting transistor T5 and the second light emitting transistor T6 are turned on, and a power supply voltage output from the first power supply line VDD supplies a driving voltage to the fourth node N4 through the turned-on first light emitting transistor T5, the drive transistor T3, and the second light emitting transistor T6, so as to drive the light-emitting device L to emit light.

In a drive process of the refresh frame of the pixel driving circuit, a drive current flowing through the drive transistor T3 is determined by a voltage difference between a control electrode and a first electrode of the third transistor T3. Because the voltage of the first node N1 is Vdata-|Vth|, the drive current of the drive transistor T3 is as follows.

I=K*(Vgs−Vth)²=K*[(Vdd−Vdata+|Vth|)−Vth]²=K*[(Vdd−Vdata]²

Among them, I is the drive current flowing through the drive transistor T3, i.e., a drive current for driving the light emitting device L. The K is a constant. Vgs is the voltage difference between the control electrode and the first electrode of the drive transistor T3. Vth is the threshold voltage of the drive transistor T3. Vdata is the second data voltage output by the data signal line Data. Vdd is the power supply voltage output by the first power supply terminal VDD.

The display substrate according to an embodiment of the present disclosure may be applied to a display product with any resolution.

An embodiment of the present disclosure also provides a driving method for a display substrate configured to drive the display substrate, the driving method for the display substrate may include: in at least one display frame, providing an active level signal to the second reset signal line connected with the at least one pixel driving circuit during one time period, and providing an active level signal to the second scan signal line connected with the at least one pixel driving circuit during one time period; or providing an active level signal to the second reset signal line connected with the at least one pixel driving circuit during at least two time periods, and providing an active level signal to the second scan signal line connected with the at least one pixel driving circuit during at least two time periods.

An embodiment of the present disclosure further provides a display apparatus including a display substrate.

The display substrate is the display substrate according to any of the aforementioned embodiments, and has similar implementation principles and implementation effects, which will not be repeated here.

In an exemplary implementation mode, the display apparatus may be any product or component with any display function, such as a display, a television, a mobile phone, a tablet computer, a navigator, a digital photo frame, and a wearable display product.

The drawings of the embodiments of the present disclosure only involve structures involved in the embodiments of the present disclosure, and other structures may refer to a general design.

For the sake of clarity, a thickness and size of a layer or a micro structure are enlarged in the accompanying drawings used for describing the embodiments of the present disclosure. It may be understood that when an element such as a layer, film, region, or substrate is described as being “on” or “under” another element, the element may be “directly” located “on” or “under” another element, or there may be an intermediate element.

Although the implementations of the present disclosure are disclosed above, the contents are only implementations used for ease of understanding of the present disclosure, but not intended to limit the present disclosure. Any of those skilled in the art of the present disclosure can make any modifications and variations in the implementation modes and details without departing from the spirit and scope of the present disclosure. However, the protection scope of the present disclosure should be subject to the scope defined by the appended claims.

1. A display substrate, wherein contents displayed in the display substrate comprise a plurality of display frames, the display substrate comprises: a data unit, pixel driving circuits arranged in an array, a plurality of second reset signal lines and a plurality of second scan signal lines, at least one pixel driving circuit comprises a drive transistor, a compensation transistor and a third reset transistor, wherein the drive transistor is connected with a first node, a second node and a third node respectively, the compensation transistor is connected with a second scan signal line, the first node and the third node respectively, and the third reset transistor is connected with a second reset signal line and the second node respectively; and
in at least one display frame, the data unit is configured to provide an active level signal to the second reset signal line connected with the at least one pixel driving circuit during one time period, and provide an active level signal to the second scan signal line connected with the at least one pixel driving circuit during one time period, or the data unit is configured to provide an active level signal to the second reset signal line connected with the at least one pixel driving circuit during at least two time periods, and provide an active level signal to the second scan signal line connected with the at least one pixel driving circuit during at least two time periods.

2. The display substrate of claim 1, further comprising a plurality of first scan signal lines, a plurality of first reset signal lines and a plurality of light emitting signal lines, wherein the at least one pixel driving circuit further comprises a write transistor, a first reset transistor and a first light emitting transistor, wherein the write transistor is connected with a first scan signal line and the second node respectively, the first reset transistor is connected with a first reset signal line and the third node respectively, and the first light emitting transistor is connected with a light emitting signal line and the second node respectively; and
in at least one display frame, the data unit is configured to provide an active level signal to the first scan signal line connected with the at least one pixel driving circuit during a first time period, provide an active level signal to the first reset signal line connected with the at least one pixel driving circuit during a second time period, provide an active level signal to the light emitting signal line connected with the at least one pixel driving circuit during a third time period, and provide an inactive level signal to the first scan signal line, the second scan signal line, the first reset signal line, the second reset signal line and the light emitting signal line that are connected with the at least one pixel driving circuit during a fourth time period; and
the second time period is before the first time period, and an end time of the second time period is before a start time of the first time period, the first time period is before the fourth time period, and an end time of the first time period is before a start time of the fourth time period, the fourth time period is before the third time period, and an end time of the fourth time period is a start time of the third time period.

3. The display substrate of claim 2, wherein at least one time period during which a signal of the second scan signal line connected with the at least one pixel driving circuit is an active level signal is at least partially overlapped with at least one of the first time period and the second time period, and is not overlapped with at least one of the third time period and the fourth time period; and
at least one time period during which a signal of the second reset signal line connected with the at least one pixel driving circuit is an active level signal is not overlapped with at least one of the first time period, the second time period, the third time period, and the fourth time period.

4. The display substrate of claim 3, wherein in a state in which the data unit provides an active level signal to the second reset signal line connected with the at least one pixel driving circuit during one time period, and provides an active level signal to the second scan signal line connected with the at least one pixel driving circuit during one time period, a sixth time period is at least partially overlapped with the first time period and the second time period, respectively, and a fifth time period is after the sixth time period; and
wherein the fifth time period is a time period during which the data unit provides an active level signal to the second reset signal line connected with the at least one pixel driving circuit, and the sixth time period is a time period during which the data unit provides an active level signal to the second scan signal line connected with the at least one pixel driving circuit.

5. The display substrate of claim 4, wherein a duration of the sixth time period is greater than a sum of a duration of the first time period and a duration of the second time period; and
the first time period and the second time period are within the sixth time period.

6. The display substrate of claim 5, wherein a start time of the sixth time period is before a start time of the second time period, an end time of the sixth time period is after the end time of the first time period and before a start time of the fifth time period, and an end time of the fifth time period is a start time of the fourth time period.

7. The display substrate of claim 6, wherein the data unit is further configured to provide an inactive level signal to the first reset signal line, the second reset signal line, and the light emitting signal line that are connected with the at least one pixel driving circuit during the first time period, provide an inactive level signal to the second reset signal line, the first scan signal line, and the light emitting signal line that are connected with the at least one pixel driving circuit during the second time period, provide an inactive level signal to the first reset signal line, the second reset signal line, the first scan signal line, and the second scan signal line that are connected with the at least one pixel driving circuit during the third time period, and provide an inactive level signal to the first reset signal line, the first scan signal line, the second scan signal line and the light emitting signal line that are connected with the at least one pixel driving circuit during the fifth time period.

8. The display substrate of claim 3, wherein in a state in which the data unit provides an active level signal to the second reset signal line connected with the at least one pixel driving circuit during two time periods, and provides an active level signal to the second scan signal line connected with the at least one pixel driving circuit during two time periods, a seventh time period is at least partially overlapped with a fifth time period, an eighth time period is at least partially overlapped with the first time period and the second time period, respectively, and a sixth time period is after the eighth time period;
wherein the fifth time period and the sixth time period are time periods during which the data unit provides an active level signal to the second reset signal line connected with the at least one pixel driving circuit, and the fifth time period is before the sixth time period, and the seventh time period and the eighth time period are time periods during which the data unit provides an active level signal to the second scan signal line connected with the at least one pixel driving circuit, and the seventh time period is before the eighth time period, and
wherein the data unit is further configured to provide an inactive level signal to the first reset signal line, the second reset signal line, and the light emitting signal line that are connected with the at least one pixel driving circuit during the first time period, provide an inactive level signal to the second reset signal line, the first scan signal line, and the light emitting signal line that are connected with the at least one pixel driving circuit during the second time period, provide an inactive level signal to the first reset signal line, the second reset signal line, the first scan signal line, and the second scan signal line that are connected with the at least one pixel driving circuit during the third time period, provide an inactive level signal to the first reset signal line, the first scan signal line, and the light emitting signal line that are connected with the at least one pixel driving circuit during a fifth time period, and provide an inactive level signal to the first reset signal line, the first scan signal line, the second scan signal line and the light emitting signal line that are connected with the at least one pixel driving circuit during a sixth time period.

9. The display substrate of claim 8, wherein a duration of the seventh time period is greater than a duration of the fifth time period, and a duration of the eighth time period is greater than the sum of a duration of the first time period and a duration of the second time period; and
the fifth time period is within the seventh time period, and the first time period and the second time period are within the eighth time period.

10. The display substrate of claim 9, wherein a start time of the seventh time period is before a start time of the fifth time period, an end time of the seventh time period is after the start time of the fifth time period, a start time of the eighth time period is before a start time of the second time period, an end time of the eighth time period is after the end time of the first time period and before a start time of the sixth time period, an end time of the sixth time period is a start time of the fourth time period.

11. The display substrate of claim 10, wherein the duration of the eighth time period is greater than the duration of the seventh time period, the duration of the seventh time period is greater than twice a duration of a ninth time period, a start time of the ninth time period is the end time of the seventh time period, and an end time of the ninth time period is the start time of the eighth time period; and
the data unit provides an inactive level signal to the first scan signal line, the second scan signal line, the first reset signal line, the second reset signal line, and the light emitting signal line that are connected with the at least one pixel driving circuit during the ninth time period.

12. The display substrate of claim 3, wherein in a state in which the data unit provides an active level signal to the second reset signal line connected with the at least one pixel driving circuit during two time periods, and provides an active level signal to the second scan signal line connected with the at least one pixel driving circuit during two time periods, a seventh time period is at least partially overlapped with a fifth time period and the second time period, respectively, an eighth time period is at least partially overlapped with the first time period, and a sixth time period is after the eighth time period;
wherein the fifth time period and the sixth time period are time periods during which the data unit provides an active level signal to the second reset signal line connected with the at least one pixel driving circuit, and the fifth time period is before the sixth time period, and the seventh time period and the eighth time period are time periods during which the data unit provides an active level signal to the second scan signal line connected with the at least one pixel driving circuit, and the seventh time period is before the eighth time period, and
wherein the data unit is further configured to provide an inactive level signal to the first reset signal line, the second reset signal line, and the light emitting signal line that are connected with the at least one pixel driving circuit during the first time period, provide an inactive level signal to the second reset signal line, the first scan signal line, and the light emitting signal line that are connected with the at least one pixel driving circuit during the second time period, provide an inactive level signal to the first reset signal line, the second reset signal line, the first scan signal line, and the second scan signal line that are connected with the at least one pixel driving circuit during the third time period, provide an inactive level signal to the first reset signal line, the first scan signal line, and the light emitting signal line that are connected with the at least one pixel driving circuit during a fifth time period, and provide an inactive level signal to the first reset signal line, the first scan signal line, the second scan signal line and the light emitting signal line that are connected with the at least one pixel driving circuit during a sixth time period.

13. The display substrate of claim 12, wherein a duration of the seventh time period is greater than a sum of a duration of the fifth time period and a duration of the second time period, and a duration of the eighth time period is greater than a duration of the first time period; and
the second time period and the fifth time period are within the seventh time period, and the first time period is within the eighth time period.

14. The display substrate of claim 13, wherein a start time of the seventh time period is before a start time of the fifth time period, an end time of the seventh time period is after the end time of the second time period, a start time of the eighth time period is before the start time of the first time period, an end time of the eighth time period is after the end time of the first time period and before a start time of the sixth time period, an end time of the sixth time period is a start time of the fourth time period.

15. The display substrate of claim 14, wherein the duration of the seventh time period is greater than four times the duration of the eighth time period and greater than four times a duration of a ninth time period, a start time of the ninth time period is the end time of the seventh time period and an end time of the ninth time period is the start time of the eighth time period.

16. The display substrate of claim 3, wherein in a state in which the data unit provides an active level signal to the second reset signal line connected with the at least one pixel driving circuit during two time periods, and provides an active level signal to the second scan signal line connected with the at least one pixel driving circuit during two time periods, a seventh time period is at least partially overlapped with a fifth time period, an eighth time period is at least partially overlapped with the second time period, a ninth time period is at least partially overlapped with the first time period, and a sixth time period is between the ninth time period and the fourth time period;
wherein the fifth time period and the sixth time period are time periods during which the data unit provides an active level signal to the second reset signal line connected with the at least one pixel driving circuit, and the fifth time period is before the sixth time period, and the seventh time period, the eighth time period and the ninth time period are time periods during which the data unit provides an active level signal to the second scan signal line connected with the at least one pixel driving circuit, and the seventh time period is before the eighth time period, and the eighth time period is before the ninth time period, and
wherein the data unit is further configured to provide an inactive level signal to the first reset signal line, the second reset signal line, and the light emitting signal line that are connected with the at least one pixel driving circuit during the first time period, provide an inactive level signal to the second reset signal line, the first scan signal line, and the light emitting signal line that are connected with the at least one pixel driving circuit during the second time period, provide an inactive level signal to the first reset signal line, the second reset signal line, the first scan signal line, and the second scan signal line that are connected with the at least one pixel driving circuit during the third time period, provide an inactive level signal to the first reset signal line, the first scan signal line, and the light emitting signal line that are connected with the at least one pixel driving circuit during a fifth time period, and provide an inactive level signal to the first reset signal line, the first scan signal line, the second scan signal line and the light emitting signal line that are connected with the at least one pixel driving circuit during a sixth time period.

17. The display substrate of claim 16, wherein a duration of the seventh time period is greater than a duration of the fifth time period, a duration of the eighth time period is greater than a duration of the second time period, and a duration of the ninth time period is greater than a duration of the first time period; and
the fifth time period is within the seventh time period, the second time period is within the eighth time period, and the first time period is within the ninth time period.

18. The display substrate of claim 17, wherein a start time of the seventh time period is before a start time of the fifth time period, an end time of the seventh time period is after an end time of the fifth time period, a start time of the eighth time period is before a start time of the second time period, an end time of the eighth time period is after the end time of the second time period, a start time of the ninth time period is before the start time of the first time period, an end time of the ninth time period is after the end time of the first time period and before a start time of the sixth time period, and an end time of the sixth time period is a start time of the fourth time period,
wherein a duration of at least one of the seventh time period and the eighth time period is greater than the duration of the ninth time period and greater than a duration of at least one of a tenth time period and an eleventh time period, a start time of the tenth time period is the end time of the seventh time period, an end time of the tenth time period is the start time of the eighth time period, a start time of the eleventh time period is the end time of the eighth time period, and the end time of the eleventh time period is the start time of the ninth time period; and
the data unit provides an inactive level signal to the first scan signal line, the second scan signal line, the first reset signal line, the second reset signal line, and the light emitting signal line that are connected with the at least one pixel driving circuit during the tenth time period and the eleventh time period.

19-22. (canceled)

23. A display apparatus, comprising: the display substrate according to claim 1.

24. A driving method for a display substrate, for driving the display substrate according to claim 1, comprising:
in at least one display frame, providing an active level signal to the second reset signal line connected with the at least one pixel driving circuit during one time period, and providing an active level signal to the second scan signal line connected with the at least one pixel driving circuit during one time period; or providing an active level signal to the second reset signal line connected with the at least one pixel driving circuit during at least two time periods, and providing an active level signal to the second scan signal line connected with the at least one pixel driving circuit during at least two time periods.
